(19) United States
(12) Patent Application Publication
(10) Pub. No.: US 2011/0138152 A1
(43) Pub. Date: Jun. 9, 2011

(54) INSTRUCTION CONTROL DEVICE

(75) Inventor: Satoshi Ogura, Kyoto (JP)

(73) Assignee: PANASONIC CORPORATION, Osaka (JP)

(21) Appl. No.: 13/059,439

(22) PCT Filed: Aug. 18, 2009
(86) PCT No.: PCT/JP2009/003920

§ 371 Date: Feb. 17, 2011

(30) Foreign Application Priority Data
Aug. 21, 2008 (JP) 2008-213381

(51) Int. Cl. G06F 9/312; G06F 9/38

(52) U.S. Cl. 712/214; 712/E09.033; 712/E09.045

(57) ABSTRACT

A processor which executes threads having different characteristics is provided with an instruction control device. In the instruction control device, a first instruction control unit issues an instruction included in a first instruction sequence to an instruction execution unit. In addition, a second instruction control unit issues an instruction included in a second instruction sequence to the instruction execution unit. Here, the delay time of the second instruction control unit is shorter than the delay time of the first instruction control unit.

### TECHNICAL FIELD

The present invention relates to instruction control devices, and particularly to an instruction control device of a multithreading processor which runs a program to be executed in a plurality of threads by concurrently executing the threads while switching between them.

### BACKGROUND ART

With increase in performance of processors in recent years, a single processor is required to perform a wider variety of processes. In particular in multimedia apparatuses such as a digital television, it is necessary that processes such as media processing and system control be simultaneously executed. Multithreading processors have been therefore attracting attention as processors to execute a plurality of processes on a time-slice basis.

A multithreading processor switches between threads with small overhead using a technique in which a plurality of register sets is provided, and thereby characteristically executes a plurality of processes simultaneously with high efficiency.

FIG. 8 shows a configuration of an instruction control device 90 included in a conventional multithreading processor 90P.

The processor 90P includes a main memory 91P, an instruction fetch unit 92P, the instruction control device 90, and an instruction execution unit 93.

The main memory 91P stores instruction sequences each of which includes instructions to be executed by the processor 90P.

The instruction fetch unit 92P reads instruction sequences 91a and 92a, which are to be executed in different threads by the processor 90P, from the main memory 91P and provides them to the instruction control device 90.

The instruction control device 90 is configured to parallelize the instruction sequences 91a and 92a read from the main memory 91P by the instruction fetch unit 92P and to provide the parallelized instruction sequences 91a and 92a to the instruction execution unit 93P. Specifically, the instruction control device 90 provides the instruction execution unit with control information specifying an operation for executing an instruction sequence. Next, the instruction control device 90 divides instructions included in the instruction sequences into groups, generates control information specifying an operation for executing the instructions in the groups in parallel, and provides the generated control information to the instruction execution unit 93P.

It is to be noted that logically simultaneous execution of processes on a time-slice basis is referred to as “concurrent” execution of the processes. On the other hand, physically simultaneous execution of processes in periods of time overlapping each other is referred to as “parallel” execution of the processes.

The instruction control device 90 includes two instruction control units: a first instruction control unit 91 and a second instruction control unit 92.

The first instruction control unit 91 divides the instruction sequence 91a, which has been provided from the instruction fetch unit 92P and is to be executed in one of the threads, into groups through processes in four stages in a pipeline such that up to four instructions are executed in parallel. The first instruction control unit 91 then generates control information indicating a group in which up to four instructions are included, and provides the control information to the instruction execution unit 93P.

In the same manner as does the first instruction control unit 91 provide the control information of the instruction sequence 91a, the second instruction control unit 92 divides the instruction sequence 92a, which has been provided from the instruction fetch unit 92P to the second instruction control unit 92 and is to be executed in the other one of the threads, into groups through processes in four stages in a pipeline such that up to four instructions are executed in parallel. The second instruction control unit 92 then generates control information indicating a group in which up to four instructions are included, and provides the control information to the instruction execution unit 93P.

The instruction execution unit 93P executes the instructions included in the instruction sequences provided from the first instruction control unit 91 and the second instruction control unit 92. At this time, the instruction execution unit 93P concurrently executes the instructions included in the instruction sequence provided from the first instruction control unit 91 and the instructions included in the instruction sequence provided from the second instruction control unit 92. The instruction execution unit 93P executes the instructions through processes in three stages.

### CITATION LIST

### Patent Literature

[PTL 1] Japanese Patent No. 2908598 (page 36, FIG. 1)

### SUMMARY OF INVENTION

### Technical Problem

FIG. 9 two shows examples of programs: a program 81 and a program 82.

FIG. 10 shows an operation of pipelining in the case where the programs 81 and 82 are concurrently executed by the conventional instruction control device 90 in the above-described configuration.

In FIG. 10, the vertically aligned rows are separated into four parts: one top row, first four rows following the top row, second four rows following the first four rows, and three rows following the second four rows. The one top row indicates a process executed by the instruction fetch unit 92P. The first four rows indicate processes executed by the first instruction control unit 91. In other words, the first four rows indicate respective processes executed in four stages by the first instruction control unit 91. In FIG. 10, the first four rows are denoted by numeral references 91-1 to 91-4. The second four rows indicate processes executed by the second instruction control unit 92. In other words, the second four rows indicate respective processes executed in four stages by the second instruction control unit 92. In FIG. 10, the second four rows are denoted by numeral references 92-1 to 92-4. The three rows following the second four rows indicate respective processes executed in three stages by the instruction execution unit 93P. In FIG. 10, the three rows are denoted by numeral references Execution unit-1 to Execution unit-3.

There are columns laterally aligned from left to right. The leftmost one is the column of the 1st cycle, and the rightmost one is the column of the 16th cycle. Each of the columns indicates a process in each cycle of the processor 90P. Each of the rows in each of the columns indicates a process executed by the units corresponding to the row, such as the instruction execution unit 93P, in the cycle of the column.

The hatched boxes in FIG. 10 each indicate that the program 82 processed by the second instruction control unit 92 is processed in the cycle of the column by the unit corresponding to the row including the box. Similarly, the non-hatched, hollow boxes in FIG. 10 each indicate that the program 81 executed by the first instruction control unit 11 is processed in the cycle of the column by the unit corresponding to the row including the box.

Because the first instruction control unit 91 is capable of parallelizing up to four instructions, the program 81 is divided into three instruction groups of an instruction group 81a, an instruction group 81b, and an instruction group 81c (FIG. 9, FIG. 10) to be executed when the program 81 is executed. In FIG. 10, the processor 90P processes each of the instruction groups 81a, 81b, and 81c through three different process flows indicated by arrows. The hollow boxes indicate that the program 81 is divided into the three instruction groups in the four rows of the first instruction control unit 91 from the 3rd cycle through the 8th cycle.

On the other hand, although the second instruction control unit 92 is capable of parallelizing up to four instructions, the program 82 is divided into four instruction groups of an instruction group 82a, an instruction group 82b, an instruction group 82c, and an instruction group 82d when it is executed because the program 82 has register dependencies (FIG. 9, FIG. 10). In FIG. 10, the processor 90P processes each of the instruction groups 82a, 82b, 82c, and 82d through four different process flows indicated by arrows. The program 81 is divided into the three instruction groups by the second instruction control unit 91 from the 4th cycle through the 10th cycle.

In this operation, the first instruction control unit 91 executes processes in four stages. Therefore, when a process flow branches to a process of the program 81, the process is started after a branch penalty of seven cycles, which equals four cycles plus three cycles of the processes executed by the instruction execution unit 93P. In FIG. 10, the period of the branch penalty of the seven cycles is indicated executed by the upper one of the two arrows with dashed lines at the bottom of the drawing.

Similarly, the second instruction control unit 92 executes processes in four stages. Therefore, when a process flow branches to a process of the program 82, the process is started after a branch penalty of seven cycles, which equals four cycles plus three cycles of the processes executed by the instruction execution unit 93P. In FIG. 10, the period of the branch penalty of the seven cycles is indicated by the lower one of the two arrows with dashed lines at the bottom of the drawing.

In this configuration, the processor 90P concurrently executes the programs 81 and 82 and executes instruction sequences in different threads with small overhead.

However, because the instruction control device 90 in such a conventional configuration is provided with the first instruction control unit 91 and the second instruction control unit 92 each having the same number of pipeline stages and controls instructions for all the programs in a uniform manner, it is difficult for the instruction control device 90 to control instructions for programs having a variety of characteristics in a manner appropriate for the characteristics of each of the programs.

For example, in the above-described operation, the program 82, which has a parallelism degree of two instructions at the maximum, is subjected to processes more than necessary for parallelization because it is processed by the second instruction control unit 92 which is capable of parallelizing up to four instructions. In other words, using many pipeline stages causes an unnecessary delay time in the instruction control unit, and thus causing a problem of low operation efficiency of the processor 90P due to increase in a branch penalty.

The present invention has an object of providing an instruction control device which processes instruction sequences to be executed in a plurality of threads and controls instructions in a manner appropriate for each of the programs having a variety of characteristics so that the occurrence of unnecessary delay time is reduced and a processor efficiently operates.

### Solution to Problem

An instruction control device according to an aspect of the present invention is configured as follows.

An instruction control device according to an aspect of the present invention issues an instruction included in an instruction sequence to an instruction execution unit, and includes: a first instruction control unit configured to issue an instruction included in a first instruction sequence to the instruction execution unit; and a second instruction control unit configured to issue an instruction included in a second instruction sequence to the instruction execution unit, wherein a delay time which is a period of time from when the second instruction sequence is input into the second instruction control unit to when the instruction execution unit starts execution of the instruction included in the second instruction sequence, is shorter than a delay time which is a period of time when the first instruction sequence is input into the first instruction control unit to when the instruction execution unit starts execution of the instruction included in the first instruction sequence.

In the instruction control device in this configuration, an instruction sequence for which a relatively simple instruction control with a short delay time is inappropriate due to characteristics of the instruction sequence is handled as the first instruction sequence and controlled by the first instruction control unit. On the other hand, an instruction sequence which may be controlled by the second instruction control unit with no problem due to characteristics of the instruction sequence is handled as the second instruction sequence and simply controlled with a short delay time, and thus the occurrence of an unnecessary delay time is reduced. Programs having a variety of characteristics are processed by an instruction control unit selected according to the characteristics, so that an instruction control is performed efficiently with a short delay time and the processor efficiently operates.

Furthermore, an instruction control device according to an aspect of the present invention further includes a selection unit (i) configured to select the first instruction sequence from two predetermined instruction sequences obtained from a main memory and to provide the selected first instruction sequence to the said first instruction control unit, and (ii) configured to select the second instruction sequence from the two predetermined instruction sequences and to provide the selected second instruction sequence to the said second instruction control unit.

In the instruction control device in this configuration, the selection unit appropriately selects, as the first instruction sequence, an instruction sequence for which a relatively simple instruction control with a short delay time is inappropriate due to characteristics of the instruction sequence, and selects, as the second instruction sequence, an instruction sequence which may be controlled by the second instruction control unit with no problem due to characteristics of the instruction sequence, so that they are provided to the first instruction control unit and the second instruction control unit, respectively. The processor thus efficiently operates in a simple configuration.

For example, the selection unit may include a first selector circuit which selects, from the two instruction sequences, an instruction sequence to be provided to the first instruction control unit and a second selector circuit. For example, when one of the instruction sequences is selected by the second selector circuit, the first selector circuit may be configured to select the other one of the instruction sequences.

The instruction control device according to the present invention may include instruction control units which executes processes in different manners and each instruction sequence is provided to an instruction control unit appropriate for the instruction sequence in terms of characteristics of a thread in which the instruction sequence is executed.

Furthermore, the instruction control device according to the present invention, which processes a first instruction sequence and a second instruction sequence obtained from a main memory and generates control information for an instruction execution unit, may include a control-unit selection unit (selection unit), a first instruction control unit, and a second instruction control unit. The control-unit selection unit is configured to provide each of the first instruction sequence and the second instruction sequence to either of the first instruction control unit and the second instruction control unit. The first instruction control unit is configured to execute a predetermined process on the provided instruction sequence. The second instruction control unit is configured to execute, on the provided instruction sequence, a process different from the process to be executed by the first instruction control unit.

Furthermore, an instruction control device according to an aspect of the present invention may include instruction control units configured to execute processes in different manners and a control selection unit configured to provide each instruction sequence to an instruction control unit appropriate for a thread in which the instruction sequence is executed, so that an appropriate instruction control is applied to each instruction sequence to be executed in a thread having different characteristics.

Furthermore, an instruction control device according to an aspect of the present invention may include instruction control units which are capable of parallelization at different parallelism degrees, and the control-unit selection unit may be configured to select an instruction control unit appropriate for a parallelism degree of an instruction sequence to be executed in a thread and provide the instruction sequence to the selected instruction control unit.

It is to be noted that to select an instruction control unit specifically means, for example, to provide an instruction sequence to the instruction control unit and not to the another instruction control unit.

Here, in the instruction control device according to the aspect of the present invention, the first instruction control unit may be configured to parallelize the provided instruction sequence at a predetermined parallelism degree, and the second instruction control unit may be configured to parallelize the provided instruction sequence at a predetermined parallelism degree smaller than the parallelism degree at which the first instruction control unit parallelizes the instruction sequence.

Furthermore, in the instruction control device according to the aspect of the present invention, the first instruction control unit may be configured to schedule instructions based on a dependency detected in the provided instruction sequence, and the second instruction control unit may be configured to schedule instructions based on a dependency detected in the provided instruction sequence in a simple way in comparison with the first instruction control unit.

Furthermore, in the instruction control device according to the aspect of the present invention, control information is generated for the instruction execution unit by pipelining, the first instruction control unit may be configured to process the provided instruction sequence by pipelining with a predetermined number of stages, and the second instruction control unit may be configured to process the provided instruction sequence by pipelining with a predetermined number of stages which is fewer than the stages of the pipelining by the first instruction control unit.

Furthermore, in the instruction control device according the aspect of the present invention, the instruction control unit may include a first setting register and a second setting register which are rewritable by a program, the control-unit selection unit may be configured to determine a destination of the first instruction sequence based on the setting held by the first setting register and determine a destination of the second instruction sequence based on the setting held by the second setting register.

Furthermore, in the instruction control device according the aspect of to the present invention, the control-unit selection unit may be configured to monitor a parallelism degree at which each of the first instruction sequence and the second instruction sequence is parallelized by the first instruction control unit, and to provide each of the instruction sequences to the second instruction control unit when the parallelism degree of the instruction sequence is equal to or lower than a predetermined value.

Furthermore, in the instruction control device according to the aspect of the present invention, when the instruction execution unit executes an branch instruction based on the first instruction sequence or the second instruction sequence, the control-unit selection unit may be configured to provide an instruction sequence corresponding to a branch destination of the instruction sequence to the second instruction control unit.

Furthermore, in the instruction control device according to the aspect of the present invention, the control-unit selection unit may be configured to monitor provision of the first instruction sequence and the second instruction sequence to the instruction execution unit, and to provide the instruction sequences to the second instruction control unit when the instruction sequences are not being provided to the instruction execution unit.

Furthermore, in the instruction control device according to the aspect of the present invention, the control-unit selection unit is configured to monitor provision of the first instruction sequence and the second instruction sequence to the instruction execution unit, and to provide the instruction sequences to the first instruction control unit when the instruction sequences are sufficiently being provided to the instruction execution unit.

Furthermore, in the instruction control device according to the aspect of the present invention, the first setting register and the second setting register may be configured to be updated based on an attribute attached to a subroutine call instruction included in the program.

Furthermore, the instruction control device according to the aspect of the present invention may include instruction control units which detect dependencies at different levels when instructions are scheduled, and the control-unit selection unit may be configured to select an instruction control unit appropriate for the dependencies in the instructions in threads and provide the instruction sequences to be processed to the selected instruction control unit.

Furthermore, the instruction control device according to the aspect of the present invention may include instruction control units which control processes in different manners through different numbers of pipeline stages, and the control-unit selection unit may be configured to select an instruction control unit based on a trade-off between characteristics of an instruction sequence and a pipeline latency and provide the instruction sequences to be processed to the selected instruction control unit.

Furthermore, in the instruction control device according to the aspect of the present invention, a parallelism degree of the instruction sequence processed by the instruction control device may be monitored, and the control-unit selection unit is configured to select an appropriate instruction control unit according to the parallelism degree and provide the instruction sequences to be processed to the selected instruction control unit.

Furthermore, in the instruction control device according to the aspect of the present invention, the provision of instructions is monitored, and when the instruction sequences are not being provided to the instruction execution unit, the control-unit selection unit is configured to select an instruction control unit having fewer pipeline stages and provide the instruction sequence to the selected instruction control unit.

Furthermore, the instruction control device according to the aspect of the present invention may have a register which holds an attribute of each of threads processed by the instruction control device, and the control-unit selection unit may be configured to select an instruction control unit corresponding to the attribute of the thread and provide the instruction sequence to be processed to the selected instruction control unit.

Furthermore, in the instruction control device according to the aspect of the present invention, the register which holds an attribute of a thread may be rewritten by a program, and the control-unit selection unit may be configured to select an instruction control unit corresponding to the attribute of the thread and provide an instruction sequence to be processed to the selected instruction control unit.

Furthermore, in the instruction control device according to the aspect of the present invention, the register which holds an attribute of a thread may be rewritten with an attribute attached to a subroutine call instruction, and the control-unit selection unit may be configured to select an instruction control unit corresponding to the attribute of the thread and provide an instruction sequence to be processed to the selected instruction control unit.

### Advantageous Effects of Invention

In the above configuration, the instruction control device according to the present invention selects an instruction control device appropriate for each of the programs having a variety of characteristics so that the occurrence of unnecessary delay time is reduced and a processor is allowed to efficiently operate.

### BRIEF DESCRIPTION OF DRAWINGS

FIG. 1 shows a configuration of an instruction control device according to Embodiment 1.

FIG. 2 shows an operation of pipelining by the instruction control device according to Embodiment 1 when an exemplary program is executed.

FIG. 3 shows a configuration of an instruction control device according to Embodiment 2.

FIG. 4 shows an operation of pipelining by the instruction control device according to Embodiment 2 when the exemplary program is executed for the first time.

FIG. 5 shows an operation of pipelining by the instruction control device according to Embodiment 2 when the exemplary program is executed for the second time.

FIG. 6 shows a configuration of an instruction control device according to Embodiment 3.

FIG. 7 shows an operation of pipelining by the instruction control device according to Embodiment 3 when the exemplary program is executed.

FIG. 8 shows a configuration of an instruction control device in a conventional configuration.

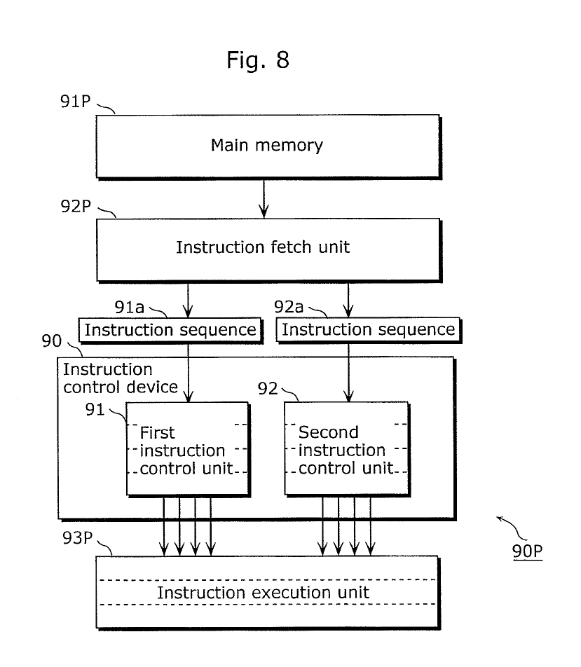

FIG. 9 shows the exemplary program.

FIG. 10 shows an operation of pipelining by the instruction control device in a conventional configuration when the exemplary program is executed.

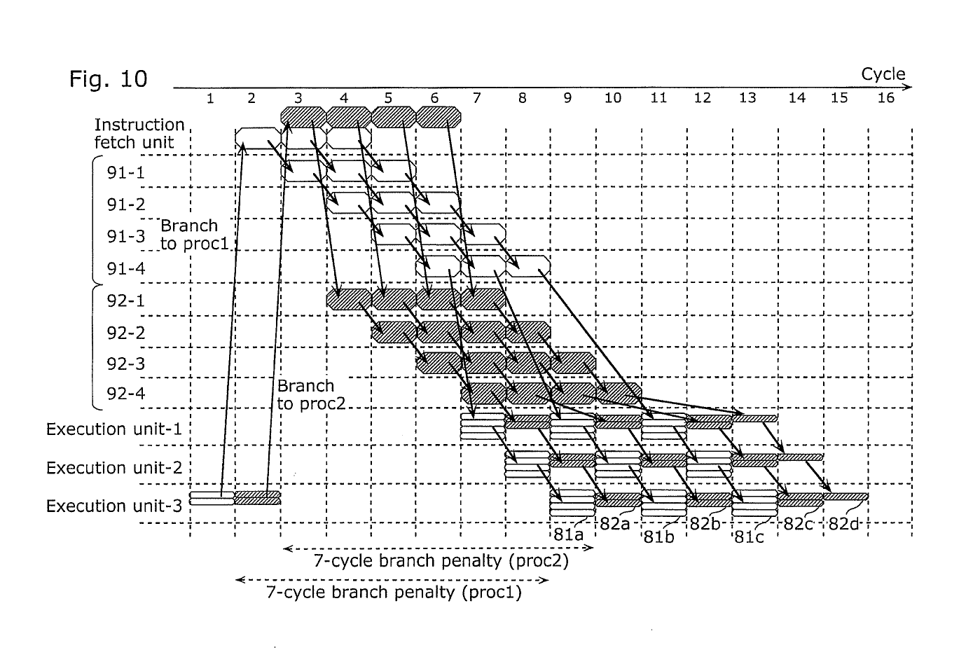

### DESCRIPTION OF EMBODIMENTS

### Embodiment 1

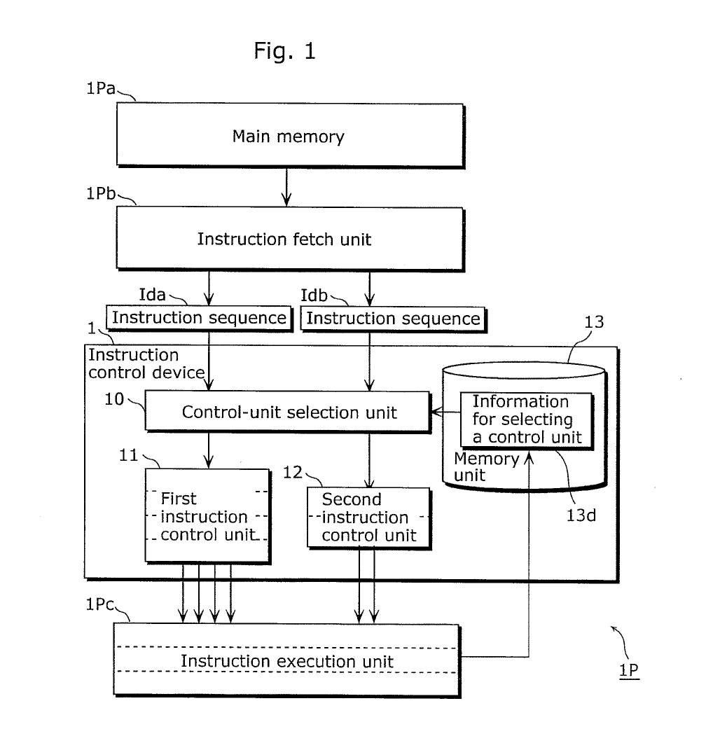

FIG. 1 shows a configuration of an instruction control device 1 according to Embodiment 1 of the present invention and a processor 1P having the instruction control device 1.

The processor 1P includes a main memory 1Pa, an instruction fetch unit 1Pb, an instruction control device 1, and an instruction execution unit 1Pc.

The main memory 1Pa stores instruction sequences each of includes instructions to be executed by the processor 1P.

The instruction fetch unit 1Pb reads instruction sequences Ida and Idb stored in the main memory 1Pa and provides them to the instruction control device 1. The instruction sequences Ida and Idb are to be executed in different threads by the processor 1P.

The instruction control device 1 is configured to parallelize the instruction sequences Ida and Idb read from the main memory 1Pa by the instruction fetch unit 1Pb and to provide the parallelized instruction sequences Ida and Idb to the instruction execution unit 1Pc.

A control-unit selection unit 10 provides each of the instruction sequences Ida and Idb to either a first instruction control unit 11 or a second instruction control unit 12 according to information for selecting a control unit 13d. Hereinafter, the instruction sequence which is selected by the control-unit selection unit 10 as an instruction sequence to be provided to the first instruction control unit 11 and is provided to the first instruction control unit 11 is referred to as a first instruction sequence. The instruction sequence which is selected by the control-unit selection unit 10 as an instruction sequence to be provided to the second instruction control unit 12 and is provided to the second instruction control unit 12 is referred to as a second instruction sequence. The first instruction sequence and the second instruction sequence are examples of a “first instruction sequence” and a “second instruction sequence” in the claims, respectively.

For example, the control-unit selection unit 10 may include a first selector circuit to which the instruction sequences Ida and Idb are input, selects a first instruction sequence to be provided to the first instruction control unit 11 from the instruction sequences Ida and Idb, and then outputs the selected instruction sequence to the first instruction control unit 11. The control-unit selection unit 10 may also include a second selector circuit to which the instruction sequences Ida and Idb are input, selects a second instruction sequence to be provided to the second instruction control unit 12 from the instruction sequences Ida and Idb, and then outputs the selected instruction sequence to the second instruction control unit 12.

In the following description, that the control-unit selection unit 10 selects the instruction sequence Ida not as an instruction sequence to be provided to the second instruction control unit Ida 12 but as an instruction sequence to be provided to the first instruction control unit 11 is described as follows. That is, it is described as that the control-unit selection unit 10 selects the first instruction control unit 12 from the first instruction control unit 11 and the second instruction control unit 12 as a destination instruction control unit of the instruction sequence Ida. Selection of the instruction control unit to which the instruction sequence Idb is provided is described in the same manner as described above.

The first instruction control unit 11 divides the instruction sequence provided from the control-unit selection unit 10 into groups such that up to four instructions are executed in parallel through processes in four stages in a pipeline, and then provides the instruction sequence to the instruction execution unit 1Pc.

The second instruction control unit 12 divides the instruction sequence provided from the control-unit selection unit 10 into groups such that up to two instructions are executed in parallel through processes in two stages in a pipeline, and then provides the instruction sequence to the instruction execution unit 1Pc.

More specifically, each of the first instruction control unit 11 and the second instruction control unit 12 generates control information specifying an operation for executing the provided instruction sequence based on the instruction sequence provided from the control-unit selection unit 10 to the instruction control unit, and provides the generated control information to the instruction execution unit 1Pc in order to cause the instruction execution unit 1Pc to execute the instruction sequence. Each of the instruction control units 11 and 12 issues instructions included in the instruction sequence indicated in the control information to the instruction execution unit 1Pc by providing the control information to the instruction execution unit 1Pc.

Each of the instruction control units detects a dependency between two instructions included in the provided instruction sequence, schedules the instructions to determine an execution order of the two instructions within the limitation of the detected dependency, and then generates control information to cause the instruction execution unit 1Pc to execute the two instructions in the determined execution order.

The dependency between the instructions may be a relation between the instructions which limits a temporal relation between times at which the two instructions are executed, such as a data dependency, a control dependency, and resource contention.

For more specific example, each of the instruction control units changes an execution order by moving forward or backward two instructions which need to be executed in a fixed execution order because of a dependency therebetween, without changing the fixed order of them, and generates control information to cause the two instructions to be executed in the changed execution order in which the fixed execution order is maintained. In the case where, for example, there is a dependency which imposes a limit that one instruction needs to be executed at a time later than a predetermined time, for example, a time at which execution of the other instruction is completed, each of the instruction control units generates control information to cause the one instruction to be executed at a time later than the predetermined time.

As described above, the first instruction control unit 11 groups up to four instructions, and the second instruction control unit 12 groups up to two instructions. Hereinafter, such numbers up to which the instruction control units group instructions are referred to as limit parallelization numbers. The limit parallelization numbers are an example of a “parallelism degree” in parallelization processing in Claims. Each of the instruction control units determines the same execution order of instructions and groups the instructions in order to cause the instruction execution unit 1Pc to execute the instructions in parallel.

Therefore, because the second instruction control unit 12 parallelizes instructions at a smaller limit parallelization number and detects only a dependency which imposes a limitation on parallelization of the instructions at the smaller maximum parallelization number, the second instruction control unit 12 schedules the instructions through relatively simple processing. In addition, because the limit parallelization number of the second instruction control unit 12 is so small, that is, the number of instructions to be executed in parallel in the same execution order is so small that the variation of execution orders to be considered to determine an optimal execution order is narrow, the second instruction control unit 12 schedules the instructions through simpler processing.

In addition, as described above, the first instruction control unit 11 performs a first instruction control in four stages, and the second instruction control unit 12 performs a second instruction control, which is different from the first instruction control, in two stages. Therefore, the delay time, which is a period of time from when an instruction control is started to when the instruction execution unit 1Pc starts execution of an instruction issued in the instruction control is four cycles long for the first instruction control unit 11, and two cycles long for the second instruction control unit 12.

A memory unit 13 holds information for selecting a control unit 13d specifying one of the first instruction control unit 11 and the second instruction control unit. The memory unit 13 includes, for example, a register which stores the information for selecting a control unit 13d.

The information for selecting a control unit 13d stored in the memory unit 13 includes first information for selecting a control unit for the instruction sequence Ida to be executed in a first thread and second information for selecting a control unit for the instruction sequence Idb to be executed in a second thread. The memory unit 13 includes two parts: a first part which includes a first register to store the first information for selecting a control unit, and a second part which includes a second register to store the second information for selecting a control unit.

The instruction execution unit 1Pc concurrently executes the instructions provided from the first instruction control unit 11 and the second instruction control unit 12 through processes in three stages. In the process in each of the stages, the instruction execution unit 1Pc concurrently executes an instruction from one of the instruction control units and an instruction from the other one of the instruction control units. The instruction execution unit 1Pc includes, for example, a temporary register which temporarily holds data, an access unit which accesses the main memory 1Pa, an arithmetic and logic unit (ALU) which performs arithmetic operations on data provided from the temporary storage register or the access unit. The instruction execution unit 1Pc causes them to operate according to control information to execute an instruction sequence indicated in the control information.

In addition, the instruction execution unit 1Pc updates a setting indicated in the information for selecting a control unit 13d when the instruction execution unit 1Pc executes a specific instruction included in the instruction sequence Ida or Idb (hereinafter referred to as an update instruction).

When receiving an instruction sequence including the update instruction, each of the first instruction control unit 11 and the second instruction control unit 12 generates control information to cause the instruction execution unit 1Pc to perform the updating.

Here, each of the information for selecting a control unit for the first thread and the information for selecting a control unit for the second thread includes a setting indicating whether or not an instruction sequence to be executed in a thread indicated in the information for selecting a control unit is a specific instruction sequence for which instructions over two are not executed in parallel even when controlled by the first instruction control unit 11. How the setting is included is described later.

Hereinafter, a maximum number of instructions to be executed in parallel when the first instruction control unit 11 has performed an instruction control of an instruction sequence is referred to as a maximum parallelization number of the instruction sequence. The specific instruction sequence is an instruction sequence for which the maximum parallelization number is equal to or smaller than the limit parallelization number of the second instruction control unit 12 (two).

The update instruction is one of various, predetermined branch instructions which causes an instruction sequence in a branch destination to be executed, such as a subroutine instruction, a method invocation instruction, a function call instruction, a goto instruction, an exception handling starting instruction, a system call instruction, and a conditional branch instruction. The update instruction is issued in order to update information for selecting a control unit 13d, which is information corresponding to a thread in which the instruction sequence of the branch destination is to be executed, to an appropriate value corresponding to the instruction sequence before the start of the execution of the instruction sequence. Here, for example, the update instruction includes a one-bit operand indicating specifying information which specifies an instruction control unit. When the update instruction is executed, the instruction execution unit 1Pc updates information for selecting a control unit 13d corresponding to a thread in which an instruction sequence is to be executed to a setting specifying the instruction control unit specified by the operand, and then starts execution of the instruction sequence. Such an update instruction includes an appropriate operand disposed in an appropriated position in an instruction sequence by a compiler or a program.

For the first thread instruction sequence Ida, the control-unit selection unit 10 obtains information for selecting a control unit for the first thread, and selects, as an instruction control unit to which the instruction sequence Ida is provided, the instruction control unit specified in the obtained information for selecting a control unit for the thread. In other words, the control-unit selection unit 10 selects the instruction sequence Ida as an instruction sequence to be provided for the specified instruction control unit. On the other hand, the control-unit selection unit 10 obtains information for selecting a control unit for the second thread, and provides the second instruction sequence Idb to the instruction control unit specified in the obtained information for selecting a control unit.

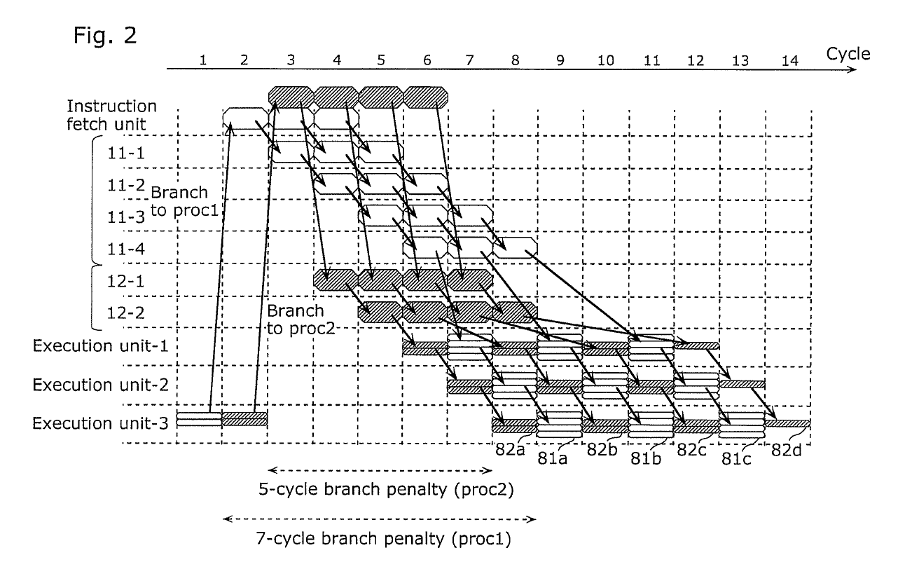

FIG. 2 shows an operation of pipelining in the case where the programs 81 and 82 are concurrently executed by the instruction control device 1 according to Embodiment 1.

In FIG. 2, the vertically aligned rows are divided into four parts: one top row, four rows following the top row, two rows following the four rows, and three rows following the two rows. The one top indicates a process executed by the instruction fetch unit 1Pb. The four rows following the top row indicate processes executed by the first instruction control unit 11, that is, the processes executed in four stages by the first instruction control unit 11. In FIG. 2, the four rows are denoted by numeral references 11-1 to 11-4. The two rows following the four rows indicate processes executed by the second instruction control unit 12, that is, the processes executed in two stages by the second instruction control unit 12. In FIG. 2, the two rows are denoted by numeral references 12-1 and 12-2. The three bottom rows following the two rows indicate processes executed in three stages by the instruction execution unit 1Pc. In FIG. 2, the three rows are denoted by numeral references Execution unit-1 to Execution unit-3.

There are columns laterally aligned from left to right. The leftmost one is the column of the 1st cycle, and the rightmost one is the column of the 15th cycle. Each of the columns indicates a process in each cycle of the processor 1P. In each of the columns, the rows indicate processes executed in the cycle of the column by corresponding components of the processor 1P, such as the instruction fetch unit 1Pb.

The hatched boxes in FIG. 2 each indicate that the program 82 processed by the second instruction control unit 12 is processed in the cycle of the column by the unit corresponding to the row including the box.

Similarly, the non-hatched, hollow boxes in FIG. 2 each indicate that the program 81 executed by the first instruction control unit 11 is processed in the cycle of the column by the unit corresponding to the row including the box.

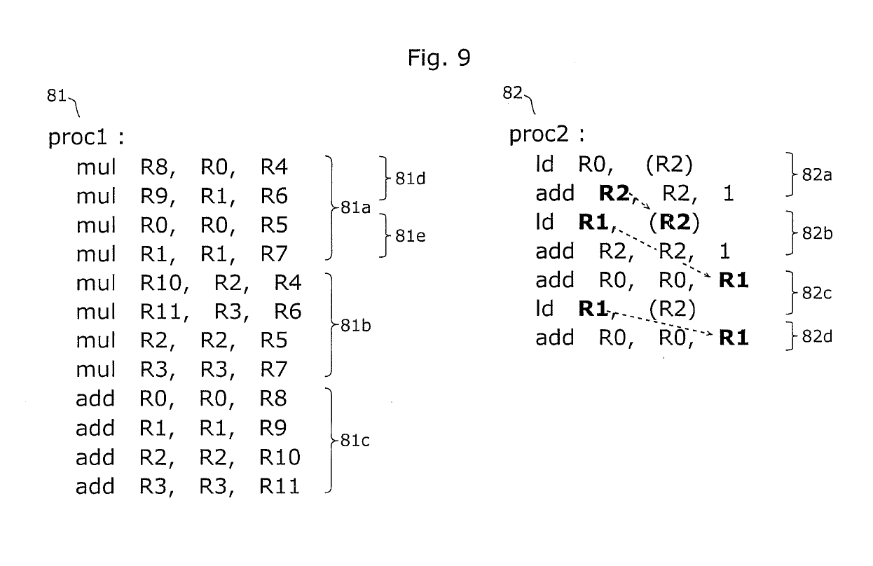

When the program 81 is executed as a first instruction sequence to be processed under an instruction control performed by the first instruction control unit 11, execution of a specific instruction (an update instruction as described above) provides a setting in the information for selecting a control unit 13d such that a first instruction sequence is provided to the instruction control unit 11. That is, a setting specifying the first instruction control unit 11 is included in the information for selecting a control unit of a thread of the program 81. Because the first instruction control unit 11 is capable of parallelizing up to four instructions, the program 81 is divided into three instruction groups of 81a, 81b, and 81c (see FIG. 2 and FIG. 9). In FIG. 2, the process executed by the first instruction control unit 11 is indicated by the hollow boxes in the four rows corresponding to the first instruction control unit 11.

Next, when the program 82 is executed as a second instruction sequence to be processed under an instruction control performed by the second instruction control unit 12, a specific instruction (an update instruction) is executed so that a setting for providing a second instruction sequence to the second instruction control unit 12 is included in the information for selecting a control unit 13d. Because the second instruction control unit 12 is capable of parallelizing up to two instructions, the program 82 is divided into four instruction groups of 82a, 82b, 82c, and 82d. In FIG. 2, the process executed by the second instruction control unit 12 is indicated by the hatched boxes in the two rows of the second instruction control unit 12.

In this operation, the first instruction control unit 11 executes processes in for stages and there is a delay time of four cycles indicated by the 3rd to 6th cycles shown in FIG. 2. Therefore, when a process flow branches to a process of the program 81, the process is started after a branch penalty of seven cycles, which equals the four cycles plus three cycles of the processes executed by the instruction execution unit.

Similarly, the second instruction control unit 12 executes processes in two stages and there is a delay time of two cycles of the 4th to 5th cycles shown in FIG. 2. Therefore, when a process flow branches to a process of the program 82, the process is started after a branch penalty of five cycles, which equals the two cycles plus three cycles of the processes executed by the instruction execution unit.

In this manner, the instruction control device 1 issues an instruction included in an instruction sequence to an instruction execution unit 1Pc, and includes: a first instruction control unit 11 configured to issue an instruction included in a first instruction sequence to the instruction execution unit 1Pc; and a second instruction control unit 12 configured to issue an instruction included in a second instruction sequence to the instruction execution unit 1Pc, wherein a delay time which is a period of time from when the second instruction sequence is input into the second instruction control unit 12 to when the instruction execution unit 1Pc starts execution of the instruction included in the second instruction sequence, is shorter than a delay time which is a period of time when the first instruction sequence is input into the first instruction control unit 11 to when the instruction execution unit 1Pc starts execution of the instruction included in the first instruction sequence 11.

In the instruction control device 1 according to Embodiment 1, when an instruction sequence of a program which allows few options for parallelization, such as the program 82, is a specific instruction sequence, use of the second instruction control unit 12, which has a small limit parallelization number and fewer necessary stages, for processing the specific instruction sequence reduces a delay time and thus a branch penalty, thereby allowing processing more efficiently than processing executed by processors in conventional configurations.

Although the instruction control device according to Embodiment 1 updates the information for selecting a control unit 13d by executing a specific instruction (update instruction), the specific instruction (update instruction) may be a subroutine call instruction. In this case, when a subroutine call instruction is executed, an instruction control unit is selected which is indicated in information attached to the subroutine call instruction, such as an operand. That is, the subroutine call instruction causes the instruction control unit indicated in the attached information to be selected as an instruction control unit which processes an instruction included in a subroutine called by the subroutine call instruction. In this case, when a thread in which an instruction sequence where the branch instruction is called is the same as the thread in which the subroutine call instruction is executed, a branch instruction which is an update instruction, such as the subroutine call instruction, may causes information for selecting a control unit for the thread in which the branch instruction is executed to be updated.

### Embodiment 2

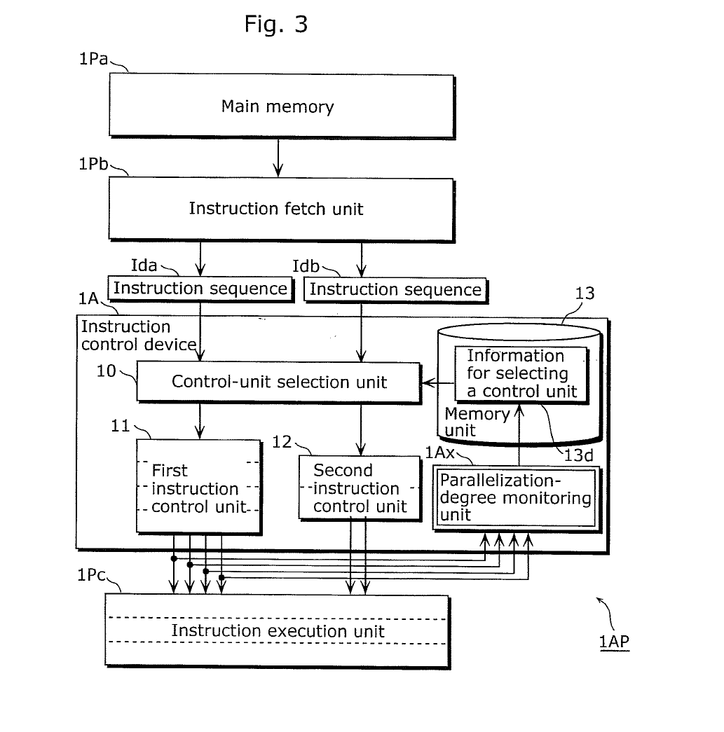

FIG. 3 shows a configuration of an instruction control device 1A according to Embodiment 2 of the present invention and a processor 1AP having the instruction control device 1A.

A main memory 1Pa, an instruction fetch unit 1Pb, a control-unit selection unit 10, a first instruction control unit 11, and a second instruction control unit 12 are configured in the same manner as in Embodiment 1.

That is, the instruction control device 1A is configured to parallelize instruction sequences Ida and Idb read from the main memory 1Pa by the instruction fetch unit 1Pb and to provide the parallelized instruction sequences Ida and Idb to the instruction execution unit 1Pc.

The control-unit selection unit 10 provides each of the instruction sequences Ida and Idb to either a first instruction control unit 11 or a second instruction control unit 12 according to information for selecting a control unit 13d.

The instruction execution unit 1Pc concurrently executes the instructions provided from the first instruction control unit 11 and the second instruction control unit 12 through processes in three stages.

The instruction control device 1A further includes a parallelization-degree monitoring unit 1Ax.

The parallelization-degree monitoring unit 1Ax monitors a parallelism degree of an instruction group processed by the first instruction control unit 11. When detecting that the maximum value of the parallelism degree is below three, the parallelization-degree monitoring unit determines a setting indicated in the information for selecting a control unit 13d such that the relevant instruction sequence is provided to the second instruction control unit 12.

The information for selecting a control unit 13d is initially set such that each of the instruction sequences Ida and Idb is provided to the first instruction control unit 11.

In Embodiment 2, it is assumed that the information for selecting a control unit 13d includes, for example, instruction sequence information specifying the instruction sequence Ida to be executed in the first thread and instruction sequence information specifying the instruction sequence Idb to be executed in the second thread. It is also assumed that the information for selecting a control unit 13d further includes information on a correspondence relation which associates the instruction sequence information with specifying information specifying one of the instruction control units. Here, it is assumed that the specifying information is set to specify the second instruction control unit 12 when the specifying information is in an initial state in which the setting of the instruction sequence information associated with the specifying information by the correspondence relation has not been determined by the parallelization-degree monitoring unit 1Ax. A memory unit 13 is provided with instruction sequence information on an instruction sequence to be executed in a thread indicated in the information for selecting a control unit obtained by the control-unit selection unit 10, and then provides, to the control-unit selection unit 10, specifying information associated with the provided instruction sequence information by the correspondence relation.

The information for selecting a control unit for each thread described in Embodiment 1 includes specifying information which is associated with instruction sequence by a correspondence relation of the instruction sequence specified by instruction sequence information of the thread.

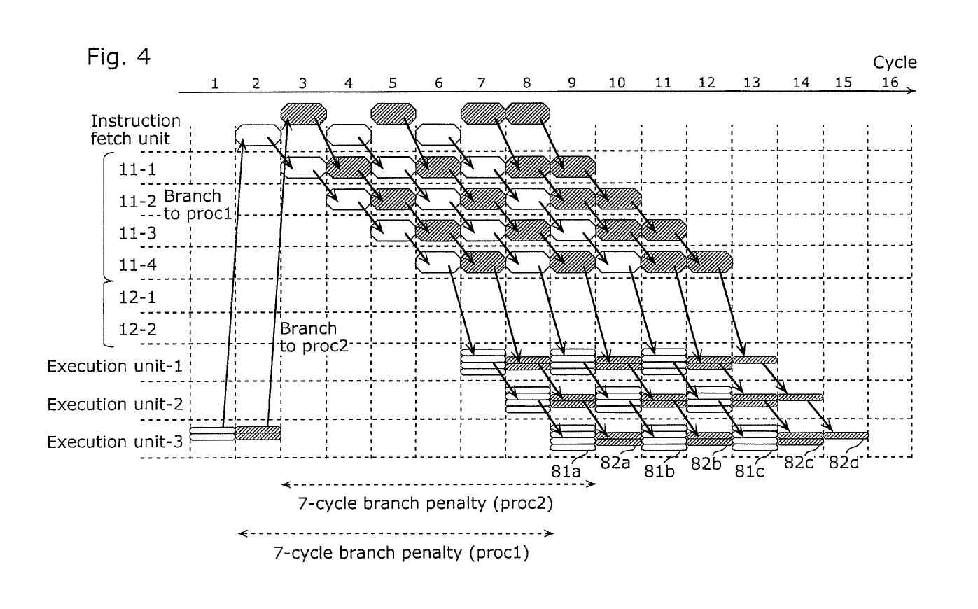

FIG. 4 shows an operation of pipelining in the case where the programs 81 and 82 are concurrently executed for the first time by the instruction control device 1A according to Embodiment 2.

When the program 81 is executed for the first time, the control-unit selection unit 10 provides the program 81 to the first instruction control unit 11 according to the information for selecting a control unit in the initial state.

Because the first instruction control unit 11 is capable of parallelizing up to four instructions, the program 81 is divided into three instruction groups of 81a, 81b, and 81c, (see FIG. 4 and FIG. 9). The parallelization-degree monitoring unit 1Ax monitors the parallelism degree of the instructions processed by the first instruction control unit 11 and detects that the instruction sequence of the program 81 is parallelized at a parallelism degree not less than three (that is, the parallelization-degree monitoring unit 1Ax detects that the program 81 is not a specific instruction sequence but an instruction sequence for which the above-mentioned maximum parallelization number is greater than the limit parallelization number (two) of the second instruction control unit 12). The parallelization-degree monitoring unit 1Ax therefore provides a setting in the information for selecting a control unit 13d such that the instruction sequence of the program 81 is processed by the first instruction control unit 11 next time. In other words, the parallelization-degree monitoring unit 1Ax keeps the setting of the specifying information for the instruction sequence of the program 81 in the initial state in which the specifying information specifies the first instruction control unit 11.

Next, when the program 82 is executed for the first time, the control-unit selection unit 10 provides the program 82 to the first instruction control unit 11 according to the information for selecting a control unit in the initial state (see FIG. 4). Then, the first instruction control unit 11 processes the program 81 and the program 82 concurrently from the 4th cycle through the 10th cycle as shown in FIG. 4.

Although the first instruction control unit 11 is capable of parallelizing up to four instructions, the program 82 is divided into four instruction groups of 82a, 82b, 82c, and 82d because the program 82 has register dependencies (see FIG. 4 and FIG. 9).

The parallelization-degree monitoring unit 1Ax monitors the parallelism degree of the instructions processed by the first instruction control unit 11 and detects that the instruction sequence of the program 81 is parallelized at a parallelism degree less than three, that is, the parallelization-degree monitoring unit 1Ax detects that the program 82 is a specific instruction sequence for which the maximum parallelization number is not more than the limit parallelization number (two) of the second instruction control unit 12. The parallelization-degree monitoring unit 1Ax therefore provides a setting in the information for selecting a control unit 13d such that the instruction sequence of the program 82 is processed by the second instruction control unit 12 next time. In other words, the parallelization-degree monitoring unit 1Ax changes the setting of the specifying information for the instruction sequence of the program 82 from the setting in the initial state in which the specifying information specifies the first instruction control unit 11 to a setting such that the specifying information specifies the second instruction control unit 12.

In this operation, the first instruction control unit 11 executes processes in for stages and there is a delay time of four cycles. Therefore, when a process flow branches to a process of the program 81, the instruction execution unit 1Pc starts the process of the program 81 after a branch penalty of seven cycles, which equals the four cycles plus three cycles of the processes executed by the instruction execution unit 1Pc.

Similarly, when a process flow branches to the program 82, the instruction execution unit 1Pc starts the process of the program 82 after a branch penalty of seven cycles.

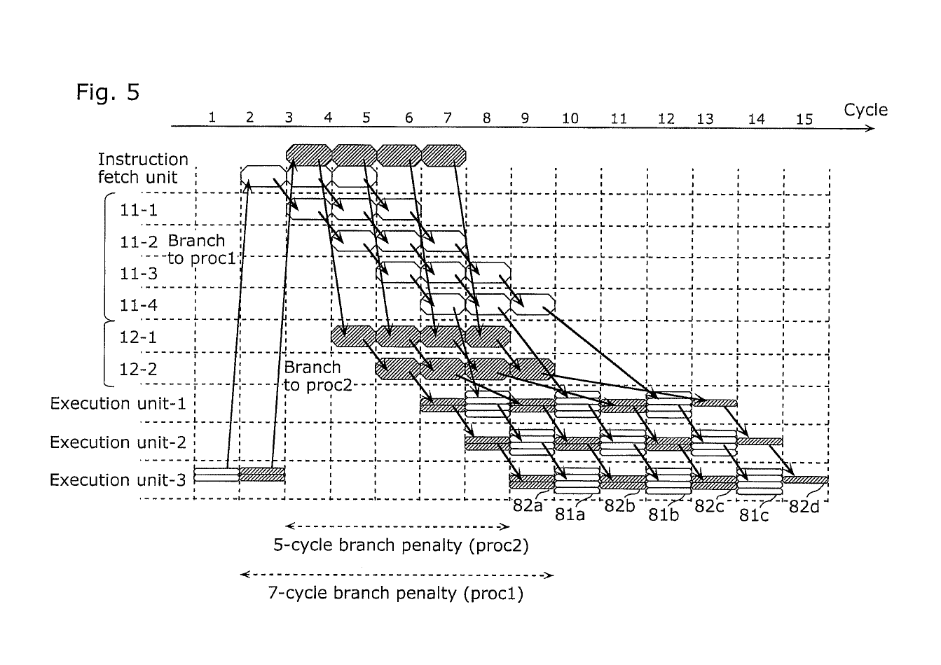

FIG. 5 shows an operation of pipelining in the case where the programs 81 and 82 are concurrently executed for the second time after the first operation shown in FIG. 4.

Because the setting for the program 81 stored in the memory unit 13 remains the same, the program 81 is divided into the three instruction groups of 81a, 81b, and 81c by the first instruction control unit 11 in the same manner as the first execution of the program 81. On the other hand, because the setting for the program 82 has been changed, the program 82 is processed by the second instruction control unit 12 according to the information for selecting a control unit 13d. The program 82 is divided into the four instruction groups of 82a, 82b, 82c, and 82d and executed by the second instruction control unit 12.

In the second operation for execution, the first instruction control unit 11 executes processes in four stages. Therefore, when a process flow branches to the program 81, the process is started after a branch penalty of seven cycles, which equals the four cycles plus three cycles of the processes executed by the instruction execution unit 1Pc.

On the other hand, the second instruction control unit 12 executes processes in two stages. Therefore, when a process flow branches to the program 82, the process is started after a branch penalty of five cycles, which equals two cycles plus three cycles of the processes executed by the instruction execution unit 1Pc.

In this manner, when an instruction sequence allows few options for parallelization (that is, an instruction sequence is a specific instruction sequence), the parallelization-degree monitoring unit 1Ax causes the processor 1AP in Embodiment 2 to use the second instruction control unit 12, which has a smaller limit parallelization number and fewer necessary stages, for processing the specific instruction sequence. This eliminates the need for explicit control by software using, for example, the above-described update instruction, and reduces a branch penalty through the monitoring and detecting by the parallelization-degree monitoring unit 1Ax, and thus easily increasing efficiency of processing in comparison with processing executed by processors 1AP in conventional configurations.

### Embodiment 3

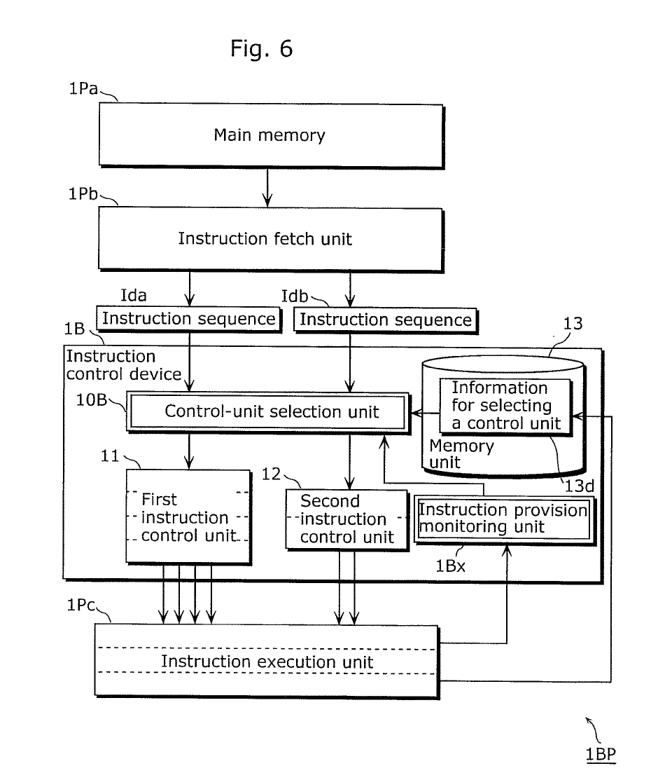

FIG. 6 shows a configuration of an instruction control device 1B according to Embodiment 3 of the present invention.

A main memory 1Pa, an instruction fetch unit 1Pb, a first instruction control unit 11, and a second instruction control unit 12 are configured in the same manner as in Embodiment 1.

That is, the instruction control device 1B is configured to parallelize instruction sequences Ida and Idb read from the main memory 1Pa by the instruction fetch unit 1Pb and to provide the parallelized instruction sequences Ida and Idb to the instruction execution unit 1Pc.

A control-unit selection unit 10B provides each of the instruction sequences Ida and Idb to either of the first instruction control unit 11 and the second instruction control unit 12 according to information for selecting a control unit 13d and a result of detection by an instruction provision monitoring unit 1Bx.

The instruction execution unit 1Pc concurrently executes the instructions provided from the first instruction control unit 11 and the second instruction control unit 12 through processes in three stages.

In addition, when the instruction execution unit 1Pc executes a specific instruction in the instruction sequence Ida or Idb (hereinafter referred to as an update instruction) as in Embodiment 1, the instruction execution unit 1Pc updates a destination of the instruction sequence indicated in the information for selecting a control unit 13d.

The instruction provision monitoring unit 1Bx detects whether or not the instruction execution unit 1Pc is executing an instruction. When a result of the detection indicates that the instruction execution unit 1Pc is not executing an instruction, the instruction provision monitoring unit 1Bx controls the control-unit selection unit 10B such that an instruction sequence is provided to the second instruction control unit 12 regardless of setting information in the information for selecting a control unit 13d.

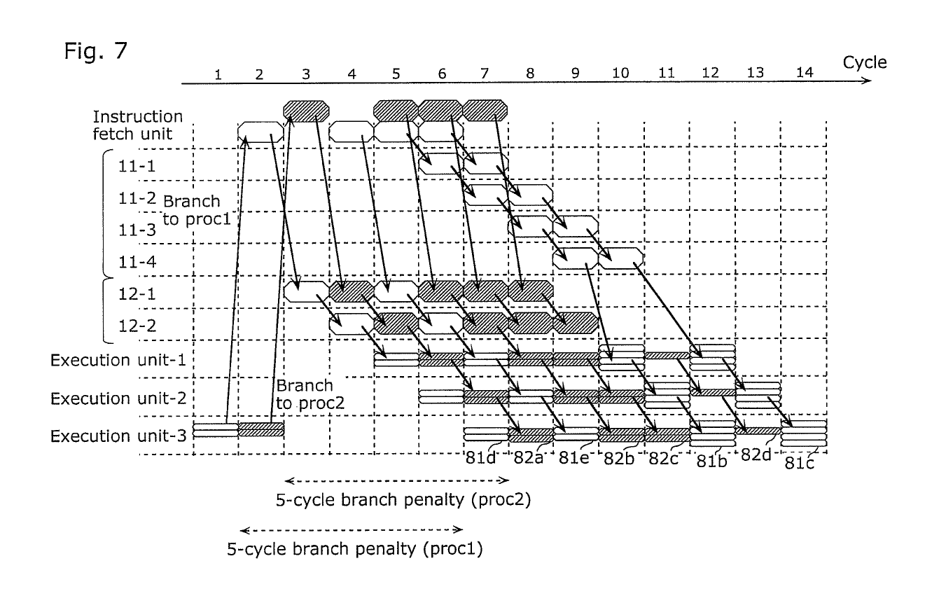

FIG. 7 shows an operation of pipelining in the case where the programs 81 and 82 are concurrently executed by the instruction control device 1B according to Embodiment 3.

When the program 81 is executed, execution of a specific instruction (an update instruction) provides a setting in the information for selecting a control unit 13d such that the program 81 is provided to the first instruction control unit 11. However, in the 3rd and 5th cycles in FIG. 7, none of instructions in an instruction sequence is executed by the instruction execution unit 1Pc when the beginning part of the program 81 (instruction groups 81d and 81e, see FIG. 7 and FIG. 9) is provided to the control-unit selection unit 10B. In FIG. 7, this is indicated by the three rows corresponding to the instruction execution unit 1Pc has no hollow boxes or hatched boxes in the columns of the 3rd and 5th cycles. Thus, under the control by the instruction provision monitoring unit 1Bx, the beginning part of the program 81 (the instruction groups 81d and 81e, see FIG. 7 and FIG. 9) is provided to the second instruction control unit 12, and the program 81 is divided into four instruction groups of the instruction group 81d, the instruction group 81e, an instruction group 81b, and an instruction group 81c (see FIG. 7 and FIG. 9). In other words, the instruction provision monitoring unit 1Bx detects, in each of the 3rd and 5th cycles, that the instruction execution unit 1Pc is not executing an instruction, and causes the control-unit selection unit 10B to select the second instruction control unit 12 as the instruction control unit for the program 81 regardless of a setting indicated in the information for selecting a control unit 13d. In the cycles following the 5th cycle, the instruction provision monitoring unit 1Bx detects that the instruction execution unit 1Pc is executing an instruction, and therefore the control-unit selection unit 10B provides the program 81 to the first instruction control unit 11 and the program 82 to the second instruction control unit 12 according to a setting indicated in the information for selecting a control unit 13d as in Embodiment 1.

When the program 82 is executed, a specific instruction (an update instruction) is executed so that a setting for providing the program 82 to the second instruction control unit 12 is included in the information for selecting a control unit 13d. The program 82 is therefore divided into four instruction groups of 82a, 82b, 82c, and 82d, because the first instruction control unit 11 parallelizes up to two instructions. In the 4th cycle, an instruction has not been executed yet, and therefore the instruction provision monitoring unit 1Bx controls the control-unit selection unit 10B so that the program 82 is provided to the second instruction control unit 12. After execution of a program is started, that is, in the 5th and later cycles, the second instruction control unit 12 continues to provide the program 82 to the second instruction control unit 12 according to the setting indicated in the information for selecting a control unit 13d.

In the above operation, the second instruction control unit 12 executes processes in two stages. Therefore, when a process flow branches to a process of the program 81, the process is started after a branch penalty of five cycles, which equals two cycles plus three cycles of the processes executed by the instruction execution unit 1Pc.

Similarly, a process of the program 82 is started after a branch penalty of five cycles.

In this manner, in the instruction control device 1B according to Embodiment 3, when an instruction sequence which allows few options for parallelization (that is, an instruction sequence is a specific instruction sequence), use of the second instruction control unit 12, which has a small limit parallelization number and fewer necessary stages, for processing the specific instruction sequence reduces a delay time and thus a branch penalty, thereby allowing processing more efficiently than processing executed by processors in conventional configurations.

In addition, when a process flow branches, use of the second instruction control unit 12, which has fewer necessary stages, for processing the beginning part of the instruction sequence in the branch destination (the instruction groups 81d and 81e, see FIG. 7 and FIG. 9), reduces a delay time and thus a branch penalty, thereby allowing processing more efficiently than processing executed by processors in conventional configurations.

### Other Embodiments

An instruction control device according to the present invention may be implemented in the embodiments described below. In addition, each of the above-described embodiments may include part of the following description.

(A) When the information for selecting a control unit 13d indicates a setting that instruction sequences Ida and Idb which are executed in different threads are processed by the same instruction control unit, the control-unit selection unit 10 may cause the instruction control unit to process both of the instruction sequences in the cases other than the case where the setting is in an initial state as shown in FIG. 4 or the case shown in FIG. 6.

(B) The control-unit selection unit 10 may obtain information for selection specifying one of instruction sequences Ida and Idb which has a maximum parallelization number of a predetermined number. For example, the predetermined number is a number smaller than a limit parallelization number (two) of the second instruction control unit 12. Then, the control-unit selection unit 10 may select, as a second instruction sequence to be provided to the second instruction control unit 12, one of the instruction sequences Ida and Idb which is specified by the obtained information for selection to provide the selected instruction sequence to the second instruction control unit 12, and select the other instruction sequence as a first instruction sequence, to provide the other instruction sequence to the first instruction control unit 11.

(C) The processor may process an instruction sequence of only one thread. In this case, the control-unit selection unit 10 may obtain information for selecting a control unit for the instruction sequence to be executed in the one thread, and provide the instruction sequence to the instruction control unit specified in the obtained information for selecting a control unit but provide no instruction sequence to the instruction control unit other than the specified one.

(D) An instruction control device may be configured as follows. The instruction control device described in each of the above embodiments may be implemented additionally including at least part of the functions, characteristics, components of the instruction control device described below. It is to be noted that the instruction control device is not limited to the embodiment in which the functions, characteristics, or components are additionally included.

Specifically, the instruction control device includes a first instruction control unit, a second instruction control unit, and a selection unit. The first instruction control unit controls operation of an instruction execution unit which performs operation for executing one instruction sequence in order to cause the instruction execution unit to execute the instruction sequence. The second instruction control unit causes the instruction execution unit to execute another instruction sequence concurrently or in parallel with the instruction sequence which the first instruction control unit is causing the instruction execution unit to execute. The second instruction control unit is an instruction control unit which causes a second instruction control to be performed, for which a delay time is shorter than a delay time for a first instruction control under which the first instruction control unit causes an instruction sequence to be executed. Here, the delay time is a period of time from when processing of an instruction sequence is started to when executing of the instruction sequence is started. The selection unit then provides the instruction sequence to be executed by the instruction execution unit to one of the first instruction control unit and the second instruction control unit.

The selection unit may provide one of two predetermined instruction sequences, for example, two instruction sequences to be executed in different threads, to one of the instruction control units and the other instruction sequence to the other instruction control unit. The selection unit may not only provide two instruction sequences simultaneously in this manner but also only one of the instruction sequences to only one of the instruction control units.

The selection unit may operate according to a predetermined criterion for determining advantageousness of the second instruction control in a processing time (delay time) and an operation for execution (the maximum number of instructions to be executed in parallel) in comparison with the first instruction control. For example, the selection unit may provide an instruction sequence to the second instruction control unit 12 when determination information indicating that the criterion is satisfied (information for selecting a control unit) shows that the second instruction control is advantageous. The selection unit may obtain such determination information from, for example, a predetermined memory unit which stores determination information, or from a predetermined information generation unit which generates determination information.

The determination information may be information which indicates that the criterion for determining advantageousness of the second instruction control is satisfied when an instruction sequence to be executed is a specific instruction sequence having characteristics which allows the instruction sequence to be advantageously executed under the second instruction control in view of a processing time and an operation for execution.

The criterion may be a criterion as to whether or not the maximum parallelization number of an instruction sequence (four for the program 81 and two for the program 82) is not more than a smaller one of the limit parallelization numbers (four for the first instruction control unit 11 and two for the second instruction control unit 12, thus two is the smaller one), each of which is the limit number of instructions parallelized by the instruction control unit. For example, the criterion may be a criterion for determining that processing executed by the instruction control unit of a shorter processing time (the instruction control unit 12) is advantageous when the maximum parallelization number is not more than the smaller limit parallelization number and the operations for execution to be performed by the instruction control units are the same or of predetermined similarity. In this manner, the criterion may be a criterion for determining that an instruction control of a shorter processing time (delay time) (an instruction control performed by the second instruction control unit 12) is advantageous when operations for execution by the instruction control units are the same or of predetermined similarity.

The instruction control device may detect whether or not a predetermined detecting operation which is included in at least part of an instruction control process and an operation for execution and occurs when an instruction sequence to be processed is a specific instruction sequence. The instruction control device may further include a detection unit (parallelization-degree monitoring unit 1Ax) which detects the determination information as a result of detection, and the selection unit may obtain the result of detection by the detection unit and use the obtained result as the determination information.

### INDUSTRIAL APPLICABILITY

The instruction control device according to the present invention performs instruction control appropriately for characteristics of an instruction to be executed in a thread, and is therefore applicable to providing a higher-performance information processing device which executes a plurality of threads having different characteristics, consumes less power, and is manufactured at lower cost.

### REFERENCE SIGNS LIST

1, 1A, 1B, 90 Instruction control device
10, 10B Control-unit selection unit
11, 91 First instruction control unit
12, 92 Second instruction control unit
13 Memory unit
13d Information for selecting a control unit
Ida, Idb, 91a, 92a Instruction sequence
1Ax Parallelization-degree monitoring unit
1AP, 1BP, 1P, 90P Processor
1Bx Instruction provision monitoring unit
1Pa, 91P Main memory
1Pb, 92P Instruction fetch unit
1Pc, 93P Instruction execution unit
81, 82 Program

1. An instruction control device which issues an instruction included in an instruction sequence to an instruction execution unit, said instruction control device comprising:
a first instruction control unit configured to issue an instruction included in a first instruction sequence to the instruction execution unit; and
a second instruction control unit configured to issue an instruction included in a second instruction sequence to the instruction execution unit,
wherein a delay time which is a period of time from when the second instruction sequence is input into said second instruction control unit to when the instruction execution unit starts execution of the instruction included in the second instruction sequence, is shorter than a delay time which is a period of time when the first instruction sequence is input into said first instruction control unit to when the instruction execution unit starts execution of the instruction included in the first instruction sequence,
said first instruction control unit is configured to parallelize the first instruction sequence provided to said first instruction control unit, at a predetermined parallelism degree, and
said second instruction control unit is configured to parallelize the second instruction sequence provided to said second instruction control unit, at a predetermined parallelism degree smaller than the parallelism degree at which said first instruction control unit parallelizes the first instruction sequence.

2. The instruction control device according to claim 1, further comprising
a selection unit (i) configured to select the first instruction sequence from two predetermined instruction sequences obtained from a main memory and to provide the selected first instruction sequence to the said first instruction control unit, and (ii) configured to select the second instruction sequence from the two predetermined instruction sequences and to provide the selected second instruction sequence to the said second instruction control unit.

3. The instruction control device according to claim 2,
wherein each of said first instruction control unit and said second instruction control unit is configured to generate, based on the instruction sequence provided to said instruction control unit, control information specifying an operation for executing the instruction sequence, and to provide the generated control information to the instruction execution unit.

4. (canceled)

5. The instruction control device according to claim 3,
wherein said first instruction control unit is configured to detect a dependency between two instructions included in the first instruction sequence, to schedule the two instructions to determine an execution order of the two instructions within a limitation of the detected dependency, and to generate control information such that the two instructions are executed in the determined execution order,
said second instruction control unit is configured to schedule the second instruction sequence, and to generate control information such that two instructions included in the second instruction sequence are executed in the execution order determined through the scheduling of the second instruction sequence, and
in the scheduling, said second instruction control unit is configured to detect only a dependency which imposes a limitation on the parallelizing of the second instruction sequence at the smaller parallelism degree.

6. The instruction control device according to claim 5,
wherein said first instruction control unit is configured to generate the control information for the first instruction sequence by pipelining,
said second instruction control unit is configured to generate the control information for the second instruction sequence by pipelining, and
the number of stages in the pipelining by said second instruction control unit is smaller than the number of stages in the pipelining by said first instruction control unit.

7. The instruction control device according to claim 6, further comprising
a first memory unit and a second memory unit each configured to hold specifying information specifying one of said first instruction control unit and said second instruction control unit,
wherein said selection unit is configured to
provide a predetermined one of the two instruction sequences only to said first instruction control unit when the specifying information held by said first memory unit specifies said first instruction control unit, and only to said second instruction control unit when the specifying information held by said first memory unit specifies said second instruction control unit, and
provide an other one of the two instruction sequences only to said first instruction control unit when the specifying information held by said second memory unit specifies said first instruction control unit, and only to said second instruction control unit when the specifying information held by said second memory unit specifies said second instruction control unit, and
when the instruction sequence provided to said first instruction control unit or said second instruction control unit includes a predetermined instruction to set a predetermined setting information in the specifying information, said instruction control unit provided with the instruction sequence is configured to generate control information such that the instruction execution unit sets the predetermined setting information in the specifying information.

8. The instruction control device according to claim 3, further comprising
a detection unit configured to detect a maximum number of instructions which is included in the first instruction sequence and is to be executed in parallel by the instruction execution unit as a result of the parallelization by said first instruction control unit, and to determine whether or not the first instruction sequence is a specific instruction sequence for which the detected maximum number is smaller than a predetermined number,
wherein said selection unit is configured to provide an instruction sequence determined as the specific instruction sequence only to said second instruction control unit.

9. The instruction control device according to claim 6,
wherein, when the instruction execution unit executes a predetermined branch instruction included in the first instruction sequence or the second instruction sequence, said selection unit is configured to select, as the second instruction sequence to be provided only to said second instruction control unit, a predetermined beginning part of an instruction sequence which is read from said main memory and to be executed in a branch destination of the branch instruction.

10. The instruction control device according to claim 6, further comprising:
a detection unit configured to detect whether or not the instruction execution unit is executing an instruction,
wherein, in the case where an instruction sequence is to be executed when said detection unit detects that the instruction execution unit is not executing an instruction, said selection unit is configured to provide the instruction sequence only to said second instruction control unit.

11. The instruction control device according to claim 6, further comprising
a detection unit configured to detect whether or not the instruction execution unit is executing an instruction,
wherein, only in the case where an instruction sequence is to be executed when said detection unit detects that the instruction execution unit is executing an instruction, said selection unit is configured to provide the instruction sequence to said first instruction control unit.

12. The instruction control device according to claim 7,
wherein the predetermined instruction is a predetermined branch instruction including an attribute specifying one of said first instruction control unit and said second instruction control unit, and
when an instruction sequence provided to said first instruction control unit or said second instruction control unit includes the branch instruction, said instruction control unit provided with the instruction sequence is configured to generate control information such that specifying information specifying said instruction control unit specified by the attribute of the branch instruction is set in said memory unit indicated by the branch instruction.
